(19) United States
(12) Patent Application Publication
(10) Pub. No.: US 2024/0418193 A1
(43) Pub. Date: Dec. 19, 2024

(54) One-Screw Support Leg for Furniture

(71) Applicant: Evan Clabots Design LLC

(72) Inventor: Evan Clabots, Brooklyn, NY (US)

(21) Appl. No.: 18/738,825

(22) Filed: Jun. 10, 2024

Related U.S. Application Data
(60) Provisional application No. 63/508,297, filed on Jun. 15, 2023.

(51) Int. Cl. F16B 12/44; A47C 7/00; F16B 12/10

(52) U.S. Cl. CPC F16B 12/44; A47C 7/002; F16B 12/10; F16B 2012/106; F16B 2012/446

(57) ABSTRACT

A support leg for furniture having only one opening that allows a screw to secure the support leg to one piece of furniture within the furniture assembly system is described. The support leg is constructed in such a manner that this one opening allows the support leg to support at least two pieces of furniture together within the furniture assembly system, even though the support leg is physically secured to only one piece of furniture.

### RELATED APPLICATION

This application claims the benefit of the following U.S. Provisional Patent Application, which is incorporated by reference in its entirety: Application Ser. No. 63/508,297, filed Jun. 15, 2023.

### FIELD OF THE DISCLOSURE

The field of this disclosure is related to the assembly of multiple furniture pieces using a support leg that is secured to only one piece of furniture.

### BACKGROUND

Support legs are a key feature of many furniture assembly systems. Certain support legs may perform at least two separate functions. First, the support leg may provide height-based support for a piece or pieces of furniture. This ensures that the piece or pieces of furniture are raised to a height that is comfortable for a user. Second, the support leg may be part of a support system between at least two pieces of furniture while being physically secured to only one piece of furniture within a furniture assembly system. This ensures that the at least two pieces of furniture do not separate during use and possibly injure the user. In addition, the support leg may include artistic features that add to the overall look of the furniture assembly system to which it is attached.

### SUMMARY

Described herein is a support leg for furniture having only one opening that allows a screw to secure the support leg to one piece of furniture within the furniture assembly system. The support leg is constructed in such a manner that this one opening allows the support leg to support at least two pieces of furniture together within the furniture assembly system, even though the support leg is physically secured to only one piece of furniture.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIG. 1 shows a schematic of a one-leg securing system before the securing stage begins.

FIG. 2 shows a schematic of a first step of a one-leg securing system being secured to a first piece of furniture.

FIG. 3 shows a schematic of the next step of a one-leg securing system being secured to a first piece of furniture.

FIG. 4 shows a schematic of a one-leg securing system supporting a second piece of furniture.

FIG. 5 shows a schematic of one-leg securing system variations.

FIGS. 6A and 6B show a schematic of assembling furniture using one-leg securing systems.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

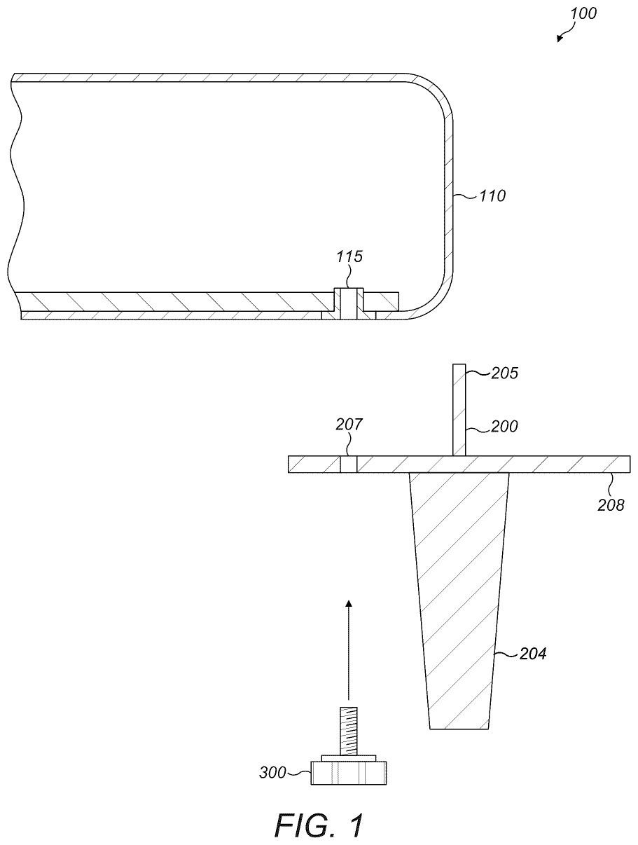

Shown in FIGS. 1-4 are cross section schematics of an exemplary support leg being installed within a furniture assembly system.

FIG. 1 shows a schematic 100 of a one-leg securing system before the securing stage begins. Shown is a first piece of furniture 110, a securing mechanism 300 and a support leg 200. The first piece of furniture 110 includes a receptacle 115 capable of receiving and securing the securing mechanism 300. To secure the securing mechanism 300, the receptacle 115 may have internal screw or nut threads that interface with the securing mechanism 300. For example, the securing mechanism 300 may be a screw and the nut threads may act as a bolt in a bolt/nut system.

The support leg 200 includes a base 204 with a horizontal protrusion 208 installed on top of the base 204, and a vertical protrusion 205 installed on top of the horizontal protrusion 208. The horizontal protrusion includes a securing hole 207 that is capable of securely holding the securing mechanism 300 that passes through the securing hole 207. To secure the securing mechanism 300, the securing hole 207 may have internal screw or nut threads that are compatible with the securing mechanism 300 (acting as a bolt in a bolt/nut system).

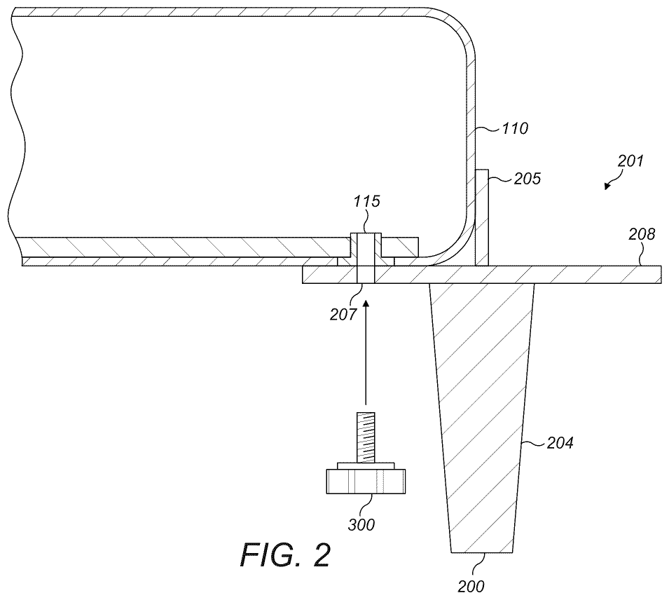

FIG. 2 shows a schematic 201 of a first step of a one-leg securing system being secured to a first piece of furniture. Shown is the next step of securing the support leg 200 to the first piece of furniture 110 by aligning the securing hole 207 with the receptacle 115.

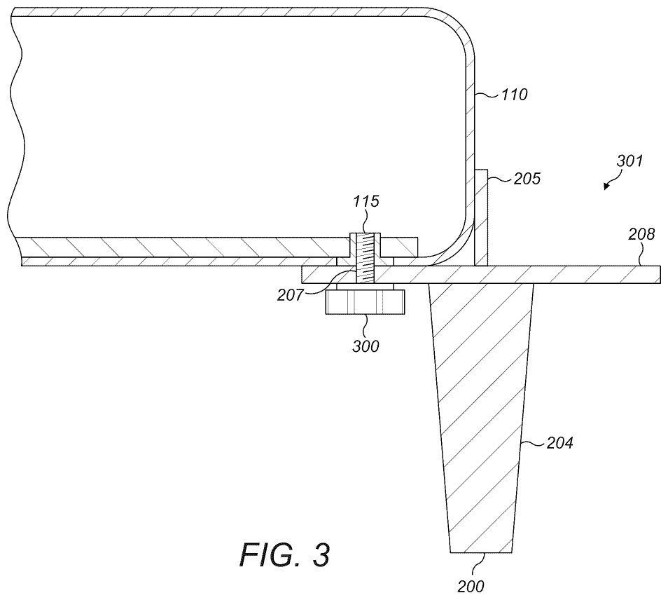

FIG. 3 a schematic 301 of the next step of a one-leg securing system being secured to a first piece of furniture. Shown is the support leg 200 being secured to the first piece of furniture 110 by inserting the securing mechanism 300 through the securing hole 207 and into the receptacle 115. The receptacle 115 is capable of securing the securing mechanism 300 through the securing hole 207 such that the support leg 200 is securely fastened to the first piece of furniture. The placement of the first piece of furniture 110 is further secured to the support leg 200 because: a) the side of the horizontal protrusion 208 having the securing hole 207 is flush with the bottom of the first piece of furniture 110; b) the side of the vertical protrusion 205 closer to the securing hole 207 is flush with the side of the first piece of furniture 110; and c) the base 204 is placed on the ground (not shown). The horizontal protrusion 208 needs to have the strength to support the weight of the first piece of furniture 110 without breaking or warping.

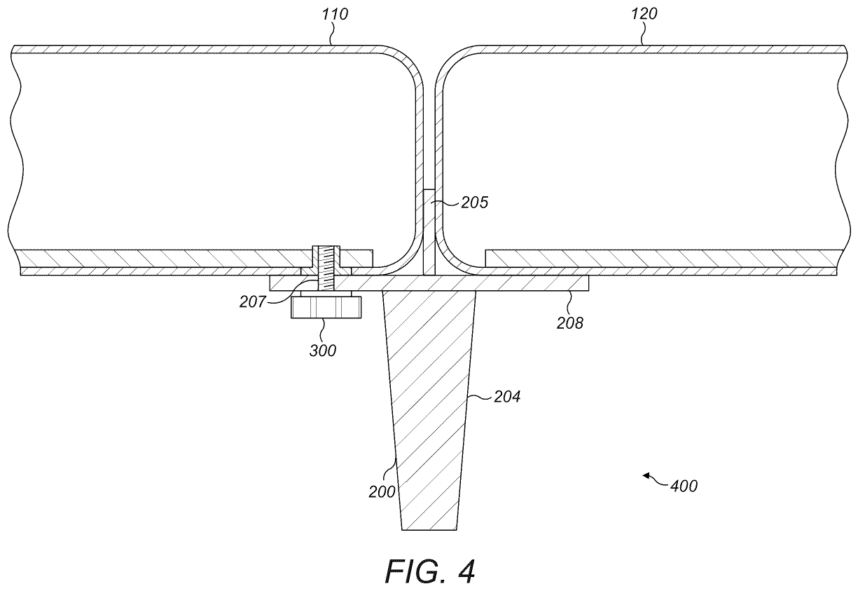

FIG. 4 shows a schematic 401 of a one-leg securing system supporting a second piece of furniture 120 to the support leg 200 by: a) placing the bottom of the second piece of furniture 120 flush to the side of the horizontal protrusion 208 not having the securing hole 207; and b) placing the side of the second piece of furniture 120 flush with the side of the vertical protrusion 205 away from the securing hole 207. The horizontal protrusion 208 needs to have the strength to support the weight of the first piece of furniture 110 and the second piece of furniture 120 without breaking or warping.

The structure of the support leg 200 provides the ability to support at least two pieces of furniture within a furniture assembly system even though it is physically secured via securing mechanism 300 to only one piece of furniture. This structure of the support leg 200 includes presence of the vertical protrusion 205 that rests flush with the sides of at least two pieces of furniture, and the horizontal protrusion 208 that rests flush with the bottoms of at least two pieces of furniture. When the support leg 200 is so installed, the presence of the at least two pieces of furniture prevents undue rotation of the support leg 200 about the axis formed by the securing hole 207, the receptacle 115, and the securing mechanism 300. This prevention of undue rotation adds stability to the furniture assembly system.

Although only two pieces of furniture are shown in FIGS. 1-4, additional pieces of furniture may be placed flush with the horizontal protrusion 208 and/or the vertical protrusion 205. The ability of placing these additional pieces of furniture on the support leg 200 will depend on the size of the first piece of furniture 110, the second piece of furniture 120, the horizontal protrusion 208, and the vertical protrusion 205.

Because the support leg 200 only has one securing hole 207, supporting any additional pieces of furniture within the furniture assembly system may arise from other devices or arrangements within the furniture assembly system. Such devices may include another support leg installed at the other end of any additional piece of furniture.

The foregoing description may have many variations. For example, although a securing mechanism 300 is described being secured with internal screw or nut threads that are compatible with the securing mechanism 300 (acting as bolt in a bolt/nut system), any securing mechanism for the securing mechanism 300 may be used. Such mechanisms may include adhesives or fastenings of any kind, including glue, hook-and-loop fasteners, and the like. Too, any substitute for the securing mechanism 300 may be used, including screws, nails, dowels, and the like.

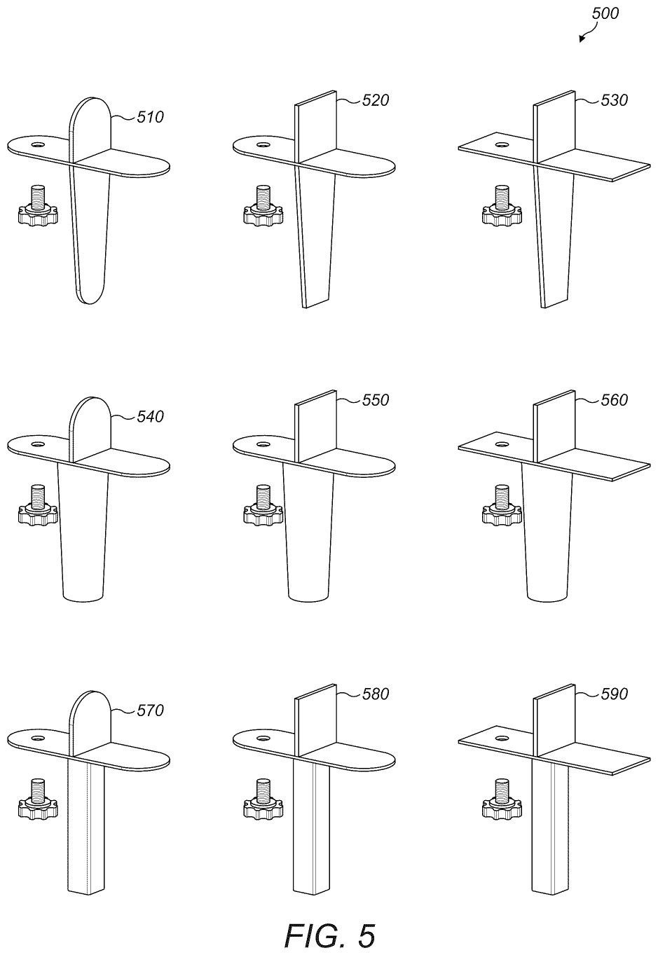

Further, the nature of each part of the support leg 200 may be varied. Exemplary variations are shown in FIG. 5. In FIG. 5:
the first variation 510 has a rounded vertical protrusion, a rounded horizontal protrusion, and a rounded straight support leg;
the second variation 520 has a squared vertical protrusion, a rounded horizontal protrusion, and a rounded straight support leg;
the third variation 530 is a squared vertical protrusion, a squared horizontal protrusion, and a squared straight support leg;
the fourth variation 540 has a rounded vertical protrusion, a rounded horizontal protrusion, and a round support leg;
the fifth variation 550 has a squared vertical protrusion, a rounded horizontal protrusion, and a round support leg;
the sixth variation 560 has a squared vertical protrusion, a squared horizontal protrusion, and a round support leg;
the seventh variation 570 has a rounded vertical protrusion, a rounded horizontal protrusion, and a squared support leg;
the eighth variation 580 has a squared vertical protrusion, a rounded horizontal protrusion, and a squared support leg; and
the ninth variation 590 has a squared vertical protrusion, a squared horizontal protrusion, and a squared support leg.

Any combination of the foregoing features may be used, or additional features may be used as substitutes.

The support leg itself may be made of metal, plastic, glass, wood, or any other suitable material, or any combination of the foregoing.

The support leg itself may be constructed such that the horizontal protrusion 208 is not equal on each side of the vertical protrusion 205. Here, the horizontal protrusion 208 comprises a first side bounded by where the horizontal protrusion 208 contacts the vertical protrusion 205 and a second side bounded by where the horizontal protrusion 208 contacts the vertical protrusion 205, where the first side has the securing hole 207 and the second side does not have the securing hole 207. To that end, one or more of the following may occur: (a) the length of the side of the horizontal protrusion 208 that has the securing hole 207 may be longer or shorter than the side of the horizontal protrusion 208 that does not have the support leg hole; (b) the width of the side of the horizontal protrusion 208 that has the securing hole 207 may be longer or shorter than the side of the horizontal protrusion 208 that does not have the support leg hole; (c) the thickness of the side of the horizontal protrusion 208 that has the securing hole 207 may be greater or lesser than the side of the horizontal protrusion 208 that does not have the support leg hole; (d) the shape of the side of the horizontal protrusion 208 that has the securing hole 207 may be different than the side of the horizontal protrusion 208 that does not have the support leg hole; and (e) the angle where the bottom of the vertical protrusion 205 meets the top of the horizontal protrusion 208 may be less than 90 degrees or greater than 90 degrees, however measured in any dimension.

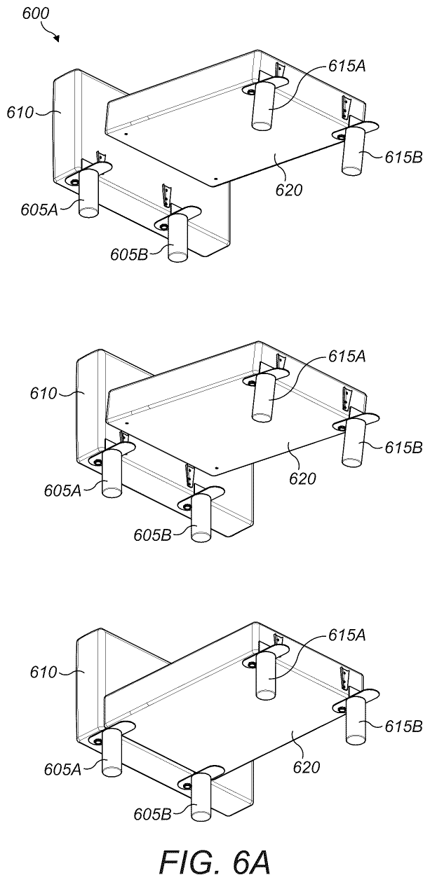

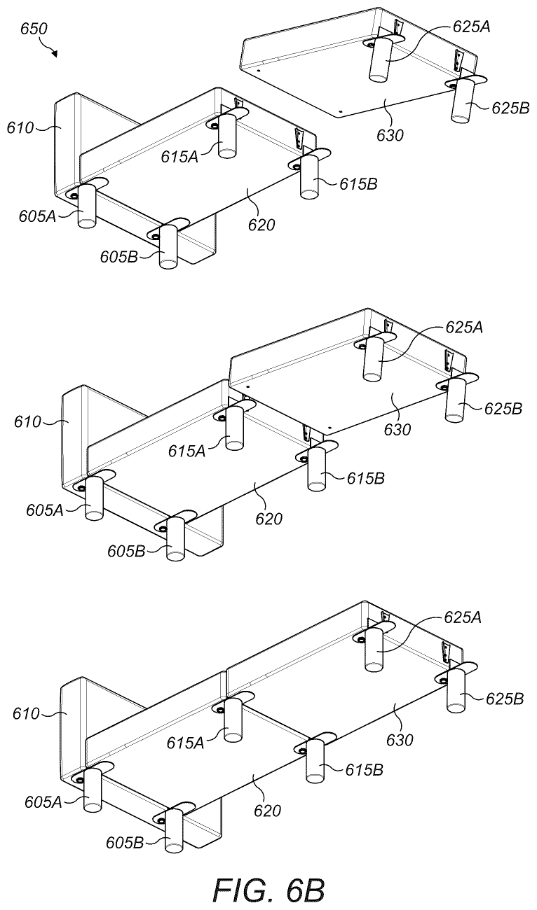

FIG. 6A shows a schematic 600 of assembling two pieces of furniture using one-leg securing systems. A vertical furniture piece 610 has two one-screw support legs 605A, 605B attached underneath. A first horizontal furniture piece 620 has two additional one-screw support legs 615A, 615B attached underneath on the proximal end. The distal end of the first horizontal furniture piece 620 does not have legs underneath. Instead the first horizontal furniture piece 620 is installed by placing the distal end on the two one-screw support legs 605A, 605B attached to the vertical furniture piece 610.

FIG. 6B shows a schematic 650 of assembling three pieces of furniture using one-leg securing systems. A vertical furniture piece 610 has two one-screw support legs 605A, 605B attached underneath. A first horizontal furniture piece 620 has two additional one-screw support legs 615A, 615B attached underneath on the proximal end. The distal end of the first horizontal furniture piece 620 does not have legs underneath. Instead the first horizontal furniture piece 620 is installed by placing the distal end on the two one-screw support legs 605A, 605B attached to the vertical furniture piece 610.

Next, a second horizontal furniture piece 630 has two additional one-screw support legs 625A, 625B attached underneath on the proximal end. The distal end of the second horizontal furniture piece 630 does not have legs underneath. Instead the second horizontal furniture piece 630 is installed by placing the distal end on the two one-screw support legs 615A, 615B attached to the first horizontal furniture piece 620. The proximal end of the second horizontal piece may include the two additional one-screw support legs 625A, 625B attached underneath so that addition furniture pieces may be attached in a like manner. Alternatively, the proximal end of the second horizontal piece may include one ore more standard support legs (not shown).

The assemblies shown in FIGS. 6A and 6B may be extended to encompass multiple variations of furniture with various combinations of vertical and horizontal furniture pieces.

All furniture pieces discussed herein may include various forms of cushioning elements.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A system comprising:
a first furniture piece;
a securing mechanism;
a support leg having a base, a horizontal protrusion installed on the base, and a vertical protrusion installed on the horizontal protrusion;
wherein the horizontal protrusion includes a securing hole capable of receiving the securing mechanism;
wherein the first furniture piece includes a receptacle capable of receiving the securing mechanism and securing the first furniture piece to the horizontal protrusion.

2. The system of claim 1, wherein the securing hole has nut threads that interface with the securing mechanism.

3. The system of claim 1, further comprising:
a second furniture piece, wherein the second furniture piece is placed on top of the horizontal protrusion without the securing mechanism securing the second furniture piece to the horizontal protrusion.

4. The system of claim 3, wherein the vertical protrusion is in between the first furniture piece and the second furniture piece.

5. The system as in claim 4, wherein at least one of the vertical protrusion, the horizontal protrusion, and the base are rounded.

6. The system as in claim 4, wherein at least one of the vertical protrusion, the horizontal protrusion, and the base are squared.

7. The system as in claim 1, wherein the horizontal protrusion comprises a first side bounded by where the horizontal protrusion contacts the vertical protrusion and a second side bounded by where the horizontal protrusion contacts the vertical protrusion, wherein the first side that has the securing hole and the second side that does not have the securing hole.

8. The system as in claim 7 wherein the first side has a first length, the second side has a second length;
wherein the first length and the second length are not equal.

9. The system as in claim 7 wherein the first side has a first shape, the second side has a second shape;
wherein the first shape and the second shape are not equal.

10. A system comprising:
a first furniture piece;
a first securing mechanism;
a first support leg having a first base, a first horizontal protrusion installed on the first base, and a first vertical protrusion installed on the first horizontal protrusion;
wherein the first horizontal protrusion includes a first securing hole capable of receiving the first securing mechanism;
wherein the first furniture piece includes a first receptacle capable of receiving the first securing mechanism and securing the first furniture piece to the first horizontal protrusion;
a second securing mechanism;
a second support leg having a second base, a second horizontal protrusion installed on the second base, and a second vertical protrusion installed on the second horizontal protrusion;
wherein the second horizontal protrusion includes a second securing hole capable of receiving the second securing mechanism;
wherein the first furniture piece includes a second receptacle capable of receiving the second securing mechanism and securing the first furniture piece to the second horizontal protrusion;
a second furniture piece;
wherein the second furniture piece is placed on top of the first horizontal protrusion without the first securing mechanism securing the second furniture piece to the first horizontal protrusion;
wherein the second furniture piece is placed on top of the second horizontal protrusion without the second securing mechanism securing the second furniture piece to the second horizontal protrusion.

11. The system of claim 10, wherein the first securing hole has first nut threads that interface with the first securing mechanism, and the second securing hole has second nut threads that interface with the second securing mechanism.

12. The system of claim 10, wherein the first vertical protrusion is in between the first furniture piece and the second furniture piece, and the second vertical protrusion is in between the first furniture piece and the second furniture piece.

13. The system as in claim 10, wherein the first furniture piece is installed in a vertical direction, and the second furniture piece is installed in a horizontal position.

14. The system of claim 10, further comprising:
a third securing mechanism;
a third support leg having a third base, a third horizontal protrusion installed on the third base, and a third vertical protrusion installed on the third horizontal protrusion;
wherein the third horizontal protrusion includes a third securing hole capable of receiving the third securing mechanism;
wherein the second furniture piece includes a second receptacle capable of receiving the third securing mechanism and securing the second furniture piece to the third horizontal protrusion;
a fourth securing mechanism;
a fourth support leg having a fourth base, a fourth horizontal protrusion installed on the fourth base, and a fourth vertical protrusion installed on the fourth horizontal protrusion;
wherein the fourth horizontal protrusion includes a fourth securing hole capable of receiving the fourth securing mechanism;
wherein the second furniture piece includes a fourth receptacle capable of receiving the fourth securing mechanism and securing the second furniture piece to the fourth horizontal protrusion;
a third furniture piece;
wherein the third furniture piece is placed on top of the third horizontal protrusion without the third securing mechanism securing the third furniture piece to the third horizontal protrusion;
wherein the third furniture piece is placed on top of the fourth horizontal protrusion without the fourth securing mechanism securing the third furniture piece to the fourth horizontal protrusion.

15. The system of claim 14, wherein the first securing hole has first nut threads that interface with the first securing mechanism, the second securing hole has second nut threads that interface with the second securing mechanism, the third securing hole has third nut threads that interface with the third securing mechanism, and the fourth securing hole has fourth nut threads that interface with the fourth securing mechanism.

16. The system of claim 14, wherein the first vertical protrusion is in between the first furniture piece and the second furniture piece, the second vertical protrusion is in between the first furniture piece and the second furniture piece, the third vertical protrusion is in between the second furniture piece and the third furniture piece, the fourth vertical protrusion is in between the second furniture piece and the third furniture piece.

17. The system as in claim 14, wherein the first furniture piece is installed in a vertical direction, the second furniture piece is installed in a horizontal position, and the third furniture piece is installed in a horizontal position.

18. A method comprising:
using a securing mechanism to secure a first furniture piece to a support leg through a securing hole in the support leg;
wherein the support leg has a base, a horizontal protrusion installed on the base, and a vertical protrusion installed on the horizontal protrusion;
wherein the horizontal protrusion includes the securing hole capable of receiving the securing mechanism;
wherein the first furniture piece includes a receptacle capable of receiving the securing mechanism and securing the first furniture piece to the horizontal protrusion;
placing a second furniture piece on top of the horizontal protrusion without the securing mechanism securing the second furniture piece to the horizontal protrusion.

19. The method of claim 18, wherein the securing hole has nut threads that interface with the securing mechanism.

20. The method of claim 18, wherein the vertical protrusion is in between the first furniture piece and the second furniture piece.
